(19) United States
(12) Patent Application Publication
(10) Pub. No.: US 2013/0218794 A1
(43) Pub. Date: Aug. 22, 2013

(54) ONLINE SYSTEM AND METHOD FOR PRESENTING AND MAINTAINING EMPLOYMENT PROFILE

(71) Applicants: Matthew Williamson SCOTT, Kingwood, TX (US); Amy Jordan SCOTT, Kingwood, TX (US); Alexandra Thomas HOLCK, Atlanta, GA (US)

(72) Inventors: Matthew Williamson SCOTT, Kingwood, TX (US); Amy Jordan SCOTT, Kingwood, TX (US); Alexandra Thomas HOLCK, Atlanta, GA (US)

(21) Appl. No.: 13/399,306

(22) Filed: Feb. 17, 2012

(51) Int. Cl. G06Q 10/06

(52) U.S. Cl. 705/321

(57) ABSTRACT

A website, system and method is provided, wherein potential job candidates may create, post and maintain up-to-date employment profiles that include employment related information, such as education, job history, professional licenses and certifications, research activities, video, audio, multi-media presentations and other information that may be useful for employers in selecting candidates to fill specific jobs. Employment profiles are broken down into tabbed categories in a brag book format for ease of use and navigation, and the employment profiles are searchable by employers and job placement recruiters.

### BACKGROUND OF THE INVENTION

The present invention relates generally to online systems whereby a person may create, maintain, and present an employment profile or curriculum vitae (CV), as well as related information and documentation. More specifically, the present invention is directed to a website and system where potential job candidates may create, post and maintain employment profiles that include employment related information, such as education, job history, professional licenses and certifications, research activities, and other information that may be useful for employers in selecting candidates to fill specific jobs. The system is primarily used by employment candidates, employers and job placement recruiters.

In years past, job seekers had few avenues for finding work. Oftentimes, a person seeking employment would simply create a resume, identify a group of employers who have available jobs that may be appropriate for the candidate's skills, and send the resume and a cover letter to all of the employers through the U.S. mail. This mass-mailing effort by job seekers has been shown to be a poor method for finding gainful employment. More recently, recruiting firms might be employed by corporations, and the recruiting firm would attempt to find a suitable candidate for the available job. However, the recruiting firms typically represent the employers, and are expensive to employ.

In the last decade or so, as with many other aspects of business, the Internet has revolutionized the job searching process. Now, there are many websites available to job seekers, where they can upload resumes and potential employers and recruiters may access and search the databases for appropriate job candidates. Unfortunately, most of these websites are general in nature, and are not focused on particular industries or job categories. Additionally, the candidates' profiles or resumes are not typically organized into any particular format, so that even if an employer or recruiter identifies a list of candidates by searching the website database, they must read through each candidate's entire profile in order to obtain specific pieces of information. For instance, if an employer is looking for a candidate having specific education and job experience, the employer must take the time to read through the entire profile for each candidate in order to find that information, because the profiles and resumes are not formatted in any particular manner.

One example of a profile management system is disclosed in U.S. Patent Application Pub. No. 2009/0055404. The system described in this reference allows a job applicant to upload his or her resume, career portfolio, and other images, text, charts, video, audio and multimedia documents. It also allows a user to have control, to some degree, over who has access to the information, and how the information, or links to the information, may be disseminated.

U.S. Patent Application Pub. No. 2011/0191663 is directed to another system for creating and displaying an online resume or profile, and provides a method for organizing the information contained therein. This reference is particularly focused on prioritizing the information within the resume or profile, and presenting the prioritized information to the searcher. Such prioritizing may be based on employer/reader preferences, search terms in a keyword search for a candidate/profile, a prioritization instruction from a resume/document owner, and/or matching data contained in a pre-stored online job post.

U.S. Pat. No. 7,840,415 discloses a website and system whereby employers are able to view personalized candidate profiles with written and video resumes, personal pictures, contact information and other personal or professional information intended to attract employers. Additionally, this system includes the ability for candidates and employers to personally meet and conduct interviews while at remote locations via a webcam.

Due to the ease of submitting employment profiles and resumes online, employers can become overwhelmed with the sheer number of applicants and resumes, each of which requires significant amounts of time for employers to review. Additionally, because employers may retain these employment profiles and resumes for some time, the information can quickly become outdated. Thus, it would be desirable to provide a system and method for creating, presenting, distributing and maintaining a current, up-to-date curriculum vitae that is broken down into an organized format that may be easily navigated by employers and recruiters alike. Further, it would be desirable to provide a system for storing the CV and profile information on a remote server, so that the information may be accessed online, and which provides multiple options for distributing, printing, and accessing the information. It would also be desirable to provide a streamlined process for remotely creating and posting reference materials, including video references and testimonials upon request.

### BRIEF SUMMARY OF THE INVENTION

In accordance with one aspect of the invention, the present invention is generally directed to an interactive tool where employees in the healthcare industry can create a custom designed career profile to set themselves apart from the competition. The present invention includes a customized “brag book” highlighting the accomplishments of a potential candidate in a visually stimulating interactive electronic format. Features of the invention include a website that allows healthcare professionals to create a personalized CV/resume, the ability of users to customize the design of their site, electronic storage of all documents that includes the ability of users to upload all of their information such as transcripts, award documents, continuing education certificates, the ability of users to upload their current CV/resume and the option to include live links to their job history, the possibility for an employment candidate to send a link to his or her CV to a potential employer via text, email, or other electronic communication, and the usage of well-organized and easily navigable tabs. A candidate's CV is searchable by potential employers and recruiters, and cross-reference searches may be performed. When a list of potential candidates is generated, searches may select target tabs within each candidate's CV in order to quickly find specific candidate information. A candidate may print his or her CV from the uploaded material so that the printed document is generated in a customizable “brag book” format, wherein the printed CV is broken down into selected tabbed sections, or, alternatively, the user has the option of printing the entire CV in a single document. Candidates may restrict, or partially restrict, access to their CV and profile. A candidate may send a request to a reference for a video reference or testimonial. The reference person is provided a link to a page that will activate a web cam and record a video reference on behalf of the candidate, and allows the reference person to submit that video testimonial or reference to the system as part of the candidate's CV. Power point presentations or videos may also be uploaded by the candidate. The present system is a consumer focused tool that will provide candidates the ability to create a personalized career profile which can be sent to companies and recruiters as well as offer the opportunity for recruiters to access professional profiles of candidates.

The website, in a preferred embodiment, includes multiple interfaces in order to provide the most efficient interface to a particular group. For instance, job candidates may see a first interface upon login, and this interface is focused on creating and maintaining the user's profile, together with tools to manage the appropriate settings, including confidentiality and access settings. Employers and recruiters may see a second interface, which is geared more toward searching for appropriate candidates for specific jobs.

### BRIEF DESCRIPTION OF THE DRAWINGS

These and other features, aspects, and advantages of the present invention will become better understood with regard to the following description, appended claims, and accompanying drawings where:

FIG. 1 shows one embodiment of an online employment profile system, including a first interface for use by job candidates;

FIG. 2 shows one embodiment of an online employment profile system, including a second interface for use by employers and job placement recruiters; and

FIG. 3 shows another embodiment of an online employment profile system, including a second interface for use by employers and job placement recruiters.

### DETAILED DESCRIPTION OF THE INVENTION

The present invention is directed to a website and system where potential job candidates may create, post and maintain employment profiles that include employment related information, such as education, job history, professional licenses and certifications, research activities, and other information that may be useful for employers in selecting candidates to fill specific jobs. The system is designed to allow job candidates to create and manage their professional profiles and CVs, and further, to allow employers, recruiters, and the like, to quickly and easily search and locate a list of appropriate candidates for available jobs. It is contemplated that this system, in a preferred embodiment, is used for job seekers and employers within the healthcare industry, but it should be understood that the system may be used for other career categories and industries.

In one embodiment, a job candidate may either upload an existing resume or CV, or may create a new one by using the website. The job candidate may elect to include any type of information that may be helpful or beneficial to obtaining employment, including a cover letter, career basics, education history, a qualification summary, experience, professional licenses and certifications, honors and awards, professional development (continuing education), affiliations and memberships, community and volunteer activities, recommendation letters and references, military service records, school transcripts, academic and teaching experience, dissertation or thesis abstract, technical and specialized skills, research activities, grant support, academic interests, professional speaking, publications, consulting experience, and/or any other related experience. Additionally, the job candidate may enter other information regarding the job that he or she is seeking, as well, including a geographical area or range in which they hope to live, salary requirements, benefits, whether they are seeking full-time or part-time employment, or other employment related factors that they are seeking as part of the job search.

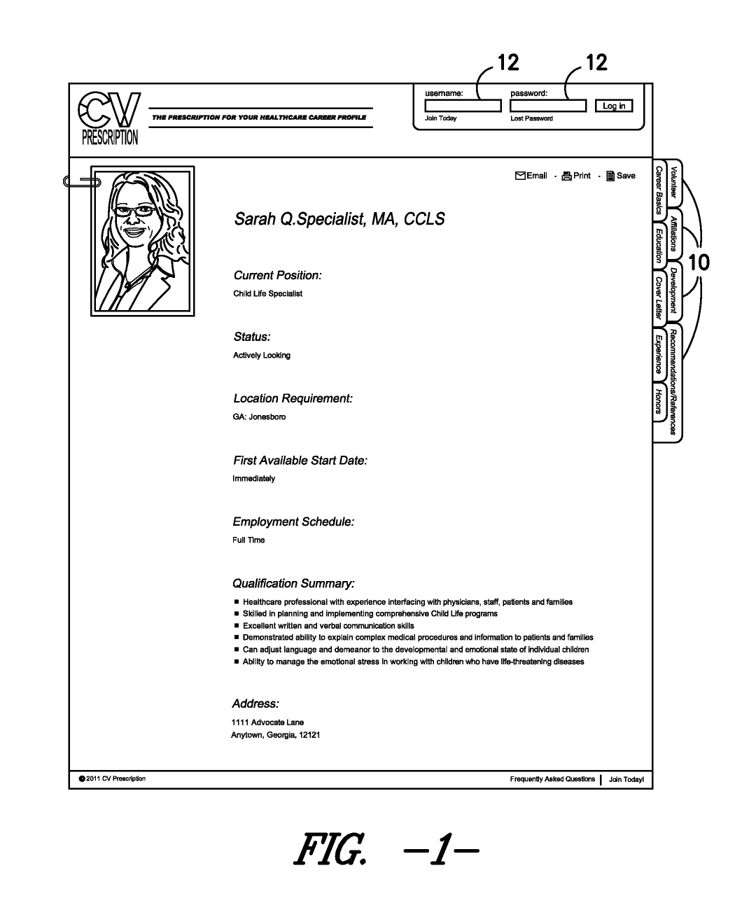

All of the information uploaded by the job candidate is stored on a remote server that is accessible via the internet from any computer, tablet, smart phone or other internet-connected device. The job candidate's information, rather than being shown on one long, single web page, may be divided into a series of easily navigable tabs 10 in a “brag book” type of format, so that an employer or recruiter may click on a tab looking for specific information, without having to read through the entire CV, as shown in FIG. 1. The tabs 10, in a preferred embodiment, may be shown vertically along the right hand side of the web page, as shown, for quick reference, although other tab orientations and designs are contemplated. There may be standard categories for tabs 10, including education, work history and school transcripts, and the job candidate may also create her own custom tabs 10, as desired. Each tab 10 shows only the information relating to the tab category, so that an employer or recruiter may find exactly the information they seek in an efficient manner, without having to review information they deem to be irrelevant or extraneous. Job candidates additionally have the ability to customize the design of their CV and profile, including a selection of templates, fonts, color, and of course, content.

The job candidate may also control access to their CV, profile and information, so that the information is not accessible to the general public. The system can enable an individual to share the information directly with another individual, or may require authentication of someone requesting to view the information, and may restrict unauthorized access to information indicated as private. In one embodiment, the job candidate may customize the privacy settings by selecting certain tabs or categories of information that are designated as private, while allowing the rest of the profile or CV to remain publicly accessible. Additionally, the job candidate may post his or her employment status to indicate either that they are currently unemployed and seeking a job, are currently employed and not seeking a job at this time, or currently employed and seeking a different job.

Because the information is stored on a remote server, which is accessible from any internet-connected device, the job candidate may edit and maintain his profile from any internet-connected device. A user name and password may be provided to the job candidate, and may be required for access to upload documents, video, audio, and the like, and to edit information. The website may include boxes for entering in user identification and password information 12, as shown in FIG. 1. Additionally, a job candidate may print their CV from any internet-connected device, and may choose from a variety of print options. For example, a job candidate may want to print the CV in its entirety as a single document, or may want to customize the printing to exclude certain sections from printing. Further, a candidate may print the CV in the brag book format, in which the sections of the CV are broken down into the tabbed categories, with each tabbed category of information included on its own sheet of paper. Preferably, the candidate may select which tabs to print, or conversely, may select which sections not to print, as desired. In this way, the job candidate may customize his or her printed CV according to the specific job that is being sought, or according to the particular company or person who will receive it. And because the CV and profile information is being constantly maintained, a job candidate (or even someone maintaining a profile who is currently happily employed) may include a link in the signature line of his or her email messages, so that the receiving party may view or peruse the publicly accessible information contained therein. Additionally, a job candidate may send an email, text, or other electronic communication with a link to the profile and CV to another party as part of a job search. If the candidate wants to allow a potential employer to view private information, the candidate may include a guest ID and password within the email or communication to the employer for that purpose.

In a preferred embodiment, the job candidate may post a video testimonial from a reference, such as a former colleague, professor, supervisor, or the like, as part of their profile or CV. In one embodiment, the job candidate may send an email to a person, requesting that the person participate in a video testimonial. The email may contain a link directing the person to a portion of the website specifically devoted to video testimonials. If the person is using a computer equipped with a web cam, then this portion of the website may include software that allows the person to operate the web cam for purposes of recording the video testimonial. Alternatively, the email itself may contain html code and other software capable of compiling the video testimonial. The person may record the video testimonial, and then review the video. If the person is unsatisfied with their first effort, they may delete that recording and try again. After the person is satisfied with their latest effort, then they may submit the video testimonial to the website. Before the video testimonial is posted as part of the job candidate's profile or CV, the job candidate has an opportunity to review the video testimonial. Although the job candidate may not edit the video testimonial, they may either post it as it was submitted, or may elect not to post it as part of their profile or CV.

This arrangement allows a streamlined process for collecting and posting video testimonials or video references. If a job candidate makes a request to a person for such a video testimonial or reference, it is desirable to make the process as quick and easy as possible for the requestee, and that is one of the objects of the current system. Alternatively, the requestee can simply record a video testimonial or reference and upload it by conventional means for review by the job candidate prior to posting.

Optionally, the system may be designed to be compatible with other networks and sites, such as social networking sites or professional networking sites. In one embodiment, it may be possible to export or synchronize a candidate's profile from the instant system to another online site or community. Preferably, the system may be able to convert a candidate's entire profile to the format of the target site or community, and further, updates to the instant site may be synchronized with the target site, so that such changes or updates need only be made one time, and are replicated to these other sites and/or online communities automatically. Privacy settings within the instant site may be used to determine what information is transferred to the target sites, and which information is synchronized. In other words, any information on the instant site that is designated as private will not be transferred to other sites, and updates to such private information will remain private on the instant site and unsynchronized with other sites.

The system may generate revenue by selling subscriptions, either weekly, monthly or yearly, for instance, to employers and recruiters. It is contemplated, although not likely, that revenue may be generated by selling subscriptions to job candidates. Other revenue streams, such as web-based advertising, are contemplated, as well.

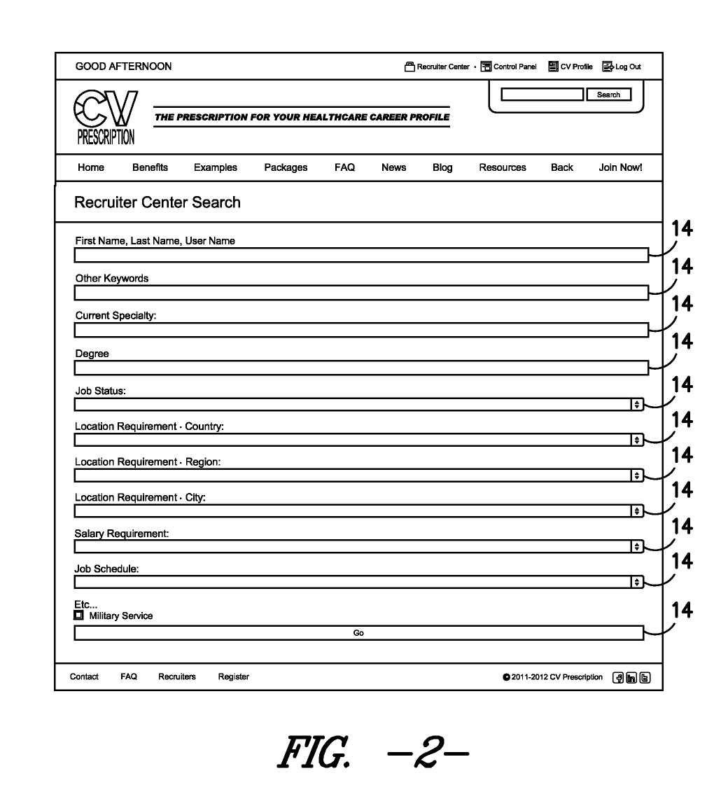

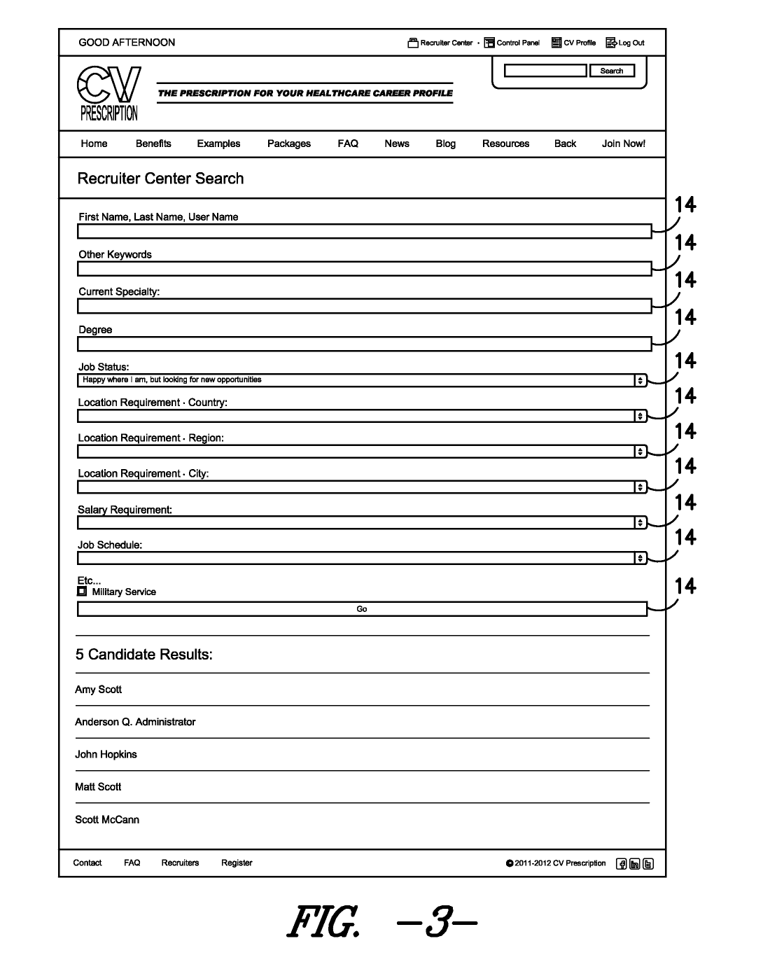

When a job candidate logs onto the website, a first interface is displayed. The first interface includes tools for creating, managing, displaying and maintaining the job candidate's profile, together with related tools and settings, as set forth herein and shown in FIG. 1. On the other hand, when an employer or recruiter logs onto the site, a second interface is displayed. This second interface is designed as a search tool, allowing employers and recruiters to search for job candidates for specific jobs, as shown in FIGS. 2 and 3. The second interface may include a series of search boxes 14 or filters, which may correlate with the tabs displayed on the job candidates' profiles. For instance, one search box 14 may be devoted to education, and another box 14 may be specific to geography, job history, or experience. Any number of search boxes 14 may be displayed and utilized, and the results of the search incorporate search requests from information entered into each box. Search results are ranked by the total number of “hits” generated from all search box entries.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A method comprising the steps of:
providing an internet connected computer for storing searchable information;
allowing a user to create an employment profile via an internet connected device, said employment profile including information relating to said user's educational and work history, wherein said information is divided into a series of information categories, and wherein each information category has a unique title;
transmitting said employment profile over said internet from said internet connected device to said internet connected computer;
storing said employment profile on said internet connected computer in a database having multiple employment profiles of other users;
allowing a searcher to search said database using a key word search via a second internet connected device;
compiling a list of user employment profiles based on said key word search;
allowing said searcher to select and view individual employment profiles from said list;
displaying said user's employment profile so that each of said unique titles of information categories is displayed;
allowing said searcher to select any of said unique titles and view said information categories associated with said selected unique title, so that said information from said selected information category is displayed, and wherein information from other non-selected information categories is not displayed.

2. The method set forth in claim 1, further including the step of allowing said user to designate said employment profile as private, so that said employment profile is not publicly accessible.

3. The method set forth in claim 1, further including the step of allowing said user to designate specific information categories as private, so that said designated information categories are not publicly accessible.

4. The method set forth in claim 1, further including the step of allowing said user and said searcher to select and print portions of said user's employment profile.

5. The method set forth in claim 1, further including the step of allowing said user to provide and transmit a digital link to said user's employment profile to another person via email or other electronic means of communication, so that said person may engage said digital link in order to view said user's employment profile.

6. The method set forth in claim 1, further including the step of allowing said user to create new information categories and to populate said new information categories with information.

7. The method set forth in claim 1, further including the step of allowing said searcher access to said database containing multiple user employment profiles in exchange for a fee.

8. The method set forth in claim 1, further including the step of allowing said user to include digital video, pictures, audio, and media presentations as part of said employment profile.

9. The method set forth in claim 1, further including the step of allowing said user to include a video testimonial from a reference person as part of said employment profile.

10. The method set forth in claim 9, further including the step of allowing said user to send an electronic communication to said reference person, requesting that said reference person record a video testimonial, and providing means for said reference person to record and submit said video testimonial for inclusion as part of said user's employment profile.

11. The method set forth in claim 10, wherein said means for said reference person to record and submit said video testimonial includes software for operating an internet connected device and associated video recording device, and further includes software for facilitating transmission of said video testimonial via said internet connection.

12. The method set forth in claim 1, including the steps of
directing said user to a first interface for creating, editing, and maintaining said user's employment profile; and
directing said searcher to a second interface for searching said database of employment profiles.
